(19) United States
(12) Patent Application Publication
(10) Pub. No.: US 2014/0246516 A1
(43) Pub. Date: Sep. 4, 2014

(54) REPLACEABLE HEAD PART OF PROBE OF SPRAY GUN

(71) Applicant: TSUNG MAO INDUSTRIAL CO., LTD., New Taipei City (TW)

(72) Inventor: Jung-Kun Huang, New Taipei City (TW)

(73) Assignee: TSUNG MAO INDUSTRIAL CO., LTD., NEW TAIPEI CITY (TW)

(21) Appl. No.: 13/783,407

(22) Filed: Mar. 4, 2013

(51) Int. Cl. B05B 11/00

(52) U.S. Cl. CPC B05B 11/0005
USPC 239/375

(57) ABSTRACT

A spray gun includes a handle, an air unit, an adjustment knob, a trigger, an air path a container. A body is connected to the rear end of the air unit and a nozzle is connected to the front end of the body. The nozzle has a paint way defined therethrough and the head part of the probe is inserted into the paint way. The probe is pivotably connected to the trigger and the probe is pulled backward by pulling the trigger. The probe returns by the spring. The head part has a positioning member and the probe has an insertion which is engaged with the positioning member to connect the head part to the probe. The head part is located in the nozzle. When replacing the nozzle or cleaning the nozzle, only the head part is needed to be removed from the spray gun.

### BACKGROUND OF THE INVENTION

(1) Field of the Invention

The present invention relates to a spray gun, and more particularly, to a spray gun with a probe which has a removable head part and the head part is replaceable.

(2) Description of the Prior Art

The conventional paint spray gun 1 is disclosed in FIGS. 1 and 2, and generally comprises a container 2, a body 3 and a control device 4. A trigger 5 is operated to activate the control device 4 to open or close the air path 11 in the handle and the air path 11 communicates with a passage 12 in the body of the spray gun 1. The passage 12 communicates with the nozzle 7 and the air exit 71. The nozzle 7 has an ejection exit 72 which is located around the tip of the nozzle 7, and a paint way 73 is defined through the nozzle 7. The trigger controls the probe 6 in the body 3 to move forward or backward. When the probe 6 moves backward, the paint in the container 2 is ejected from the ejection exit 72 by the air flow from the air exit 71. When the probe 6 moves forward, the ejection exit 72 is sealed by the probe 6. A block 10, a spring 9 and an adjustment knob 8 are located at the rear end of the probe 6, the probe 6 is adjusted to move forward or backward by rotating the adjustment knob 8 so that the paint way 73 between the probe 6 and the nozzle 7 can adjusted.

The nozzles 7 of different calibers are often installed to the spray gun for different demands, and the paint way 73 usually stocked, so that the nozzle 7 needs to be replaced and/or the nozzle 7 and the probe 6 need to be cleaned. When replacing the nozzle 7, the probe 6 has to be replaced according the new caliber of the nozzle 7. Usually, the probe 6 is removed from the rear end of the spray gun so that the adjustment knob 8, the block 10 and the spring 9 have to be removed. Therefore, there are many parts removed from and re-assembled to the spray gun, and this is a time-consuming task. If the spring 9 and the block 10 are not installed properly, the spray gun may not operate properly.

The present invention intends to provide a paint spray gun wherein the probe has a separate head part so that the shortcomings mentioned above are improved.

### SUMMARY OF THE INVENTION

The present invention relates to a spray gun and comprises a handle, an air unit, an adjustment knob, a trigger, an air path a container. The trigger controls the communication of the air path and the backward movement of a probe which has a head part connected to the front end thereof. A body is connected to the rear end of the air unit and a nozzle is connected to the front end of the body. The nozzle has a paint way defined therethrough and the head part of the probe is inserted into the paint way. A block, a spring and an adjustment knob are connected to the rear end of the probe. The container has a guide tube which is inserted into the body. The air path has two sub-paths respectively communicating with the air unit and the nozzle. The two sub-paths guide the paint in the container to be ejected from the nozzle via the paint way. The probe is pivotably connected to the trigger and the probe is pulled backward by pulling the trigger. The probe returns by the spring. The head part has a positioning member and the probe has an insertion which is engaged with the positioning member to connect the head part to the probe. The head part is located in the nozzle.

The primary object of the present invention is to provide a probe of a spray gun wherein the head part of the probe can be individually removed when replacing or cleaning the nozzle. The spring, the block and the adjustment knob do not need to be removed from the spray gun.

The probe has a replaceable head part so that the life of the probe is prolonged and the cost for material of the probe is saved. The probe provides a first clamp portion and a second clamp portion to easily assemble or disassemble the head part or the whole probe.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of a conventional paint spray gun;

FIG. 2 is a cross sectional view of the probe of the conventional paint spray gun;

FIG. 3 is a cross sectional view of the paint spray gun of the present invention;

FIG. 4 is an exploded view to show the head part and the probe of the paint spray gun of the present invention;

FIG. 5 shows the plan view of the combination of the head part and the probe of the paint spray gun of the present invention;

FIG. 6 is a cross sectional view to show the combination of the head part and the probe of the paint spray gun of the present invention;

FIG. 7 shows that the head part is removed from the probe of the paint spray gun of the present invention;

FIG. 8 is a cross sectional view to show the second embodiment of the paint spray gun of the present invention;

FIG. 9 is an exploded view to show the head part and the probe of the second embodiment of the paint spray gun of the present invention;

FIG. 10 shows the plan view of the combination of the head part and the probe of the second embodiment of the paint spray gun of the present invention;

FIG. 11 is a cross sectional view to show the combination of the head part and the probe of the second embodiment of the paint spray gun of the present invention, and

FIG. 12 shows that the head part is removed from the probe of the second embodiment of the paint spray gun of the present invention.

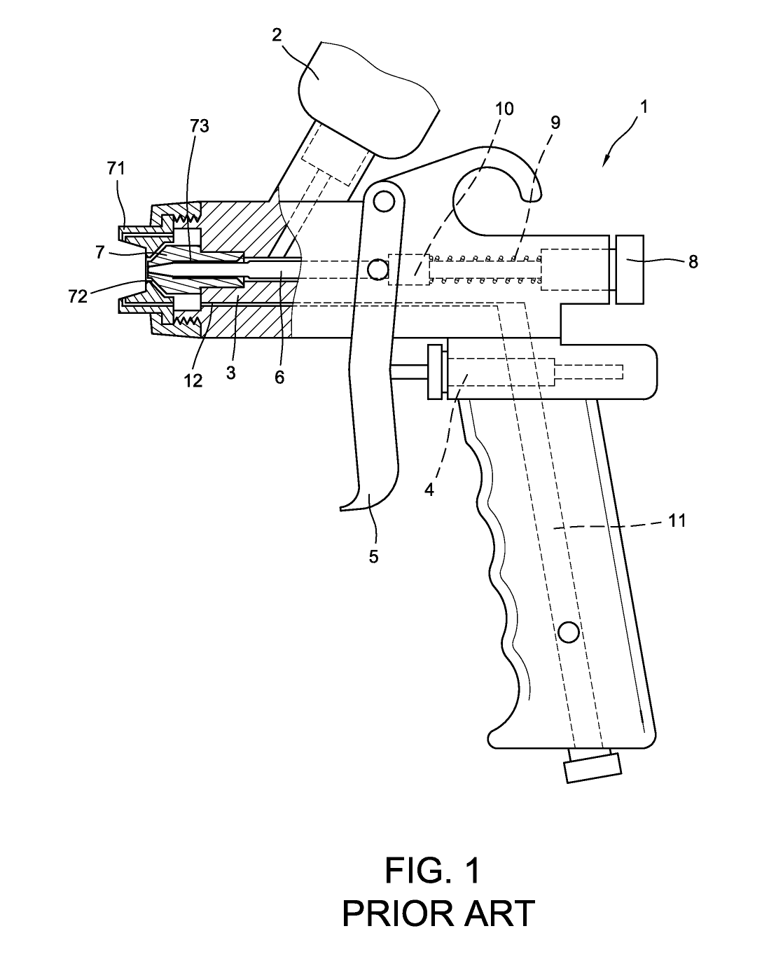

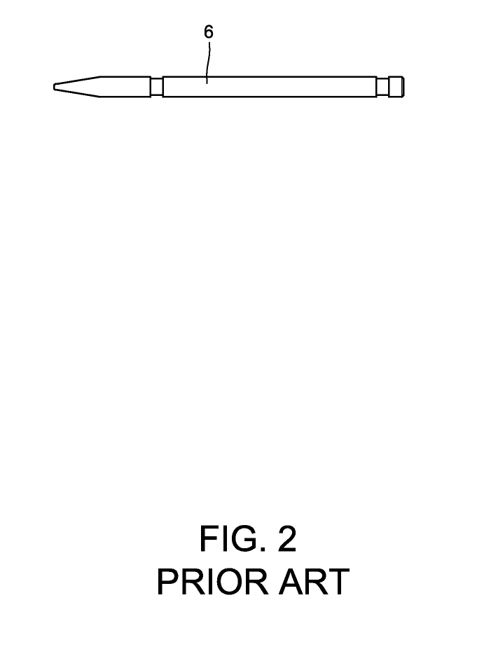

### DETAILED DESCRIPTION OF THE PREFERRED EMBODIMENT

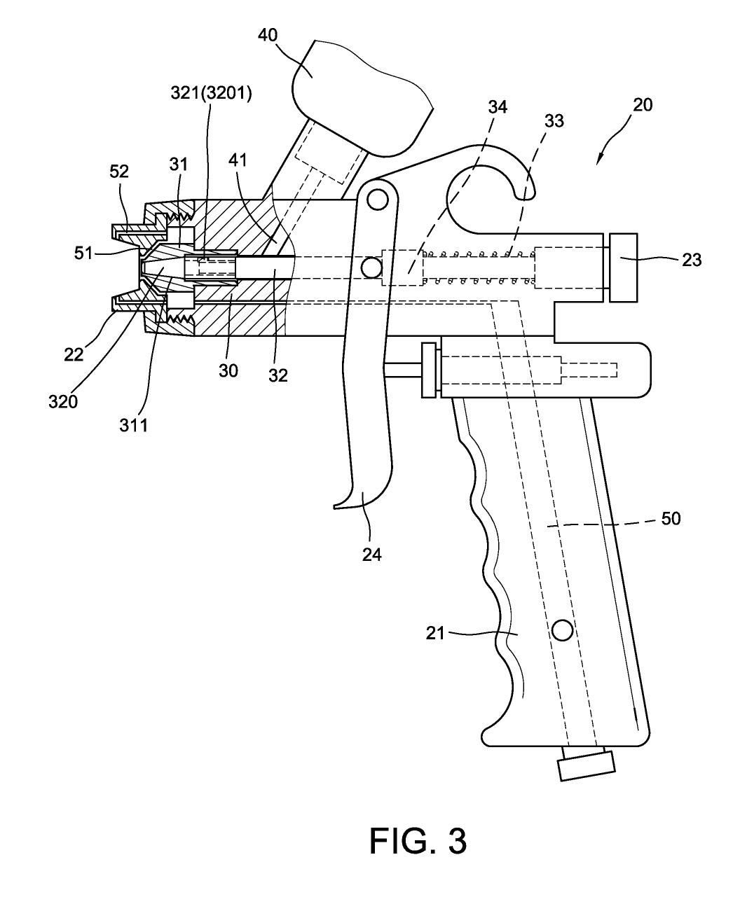

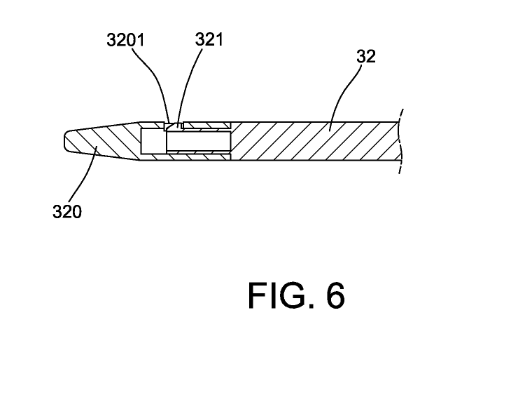

Referring to FIGS. 3 to 7, the paint spray gun 20 of the present invention comprises a body 30, a container 40 and an air path 50. The spray gun 20 has a handle 21, an air unit 22, an adjustment knob 23, a trigger 24 and the container 40 connected thereto. The trigger 24 is a lever which controls the communication of the air path 50 and the backward movement of a probe 32. The probe 32 has a head part 320 connected to a front end thereof. The body 30 is connected to the rear end of the air unit 22 and a nozzle 31 is connected to the front end of the body 30. The nozzle 31 has a paint way 311 defined therethrough and the head part 320 of the probe 32 is inserted into the paint way 311. A block 34, a spring 33 and an adjustment knob 23 are connected to the rear end of the probe 32. The rear end of the probe 32 has a recessed clamp portion 323 and the probe 32 has its middle portion pivotably connected to the trigger 24. The probe 32 is moved backward when the trigger 24 is pulled and the probe 32 returns by the spring 33. The container 40 has a guide tube 41 connected thereto which is inserted into paint way 311 in the body 30. The air path 50 has two sub-paths 51, 52 respectively communicating with the air unit 22 and the nozzle 31. The air flow in the two sub-paths 51, 52 guides the paint in the container 40 to be ejected from the nozzle 31 via the paint way 311 in the body 30. The probe 32 is pulled backward by pulling the trigger 24 so as to generate a gap to allow the paint to be ejected from the nozzle 31 via the gap. When releasing the trigger 24, the probe 32 returns by the spring 33 and air cannot enter the air path 50, and the head part 320 seals the paint way 311.

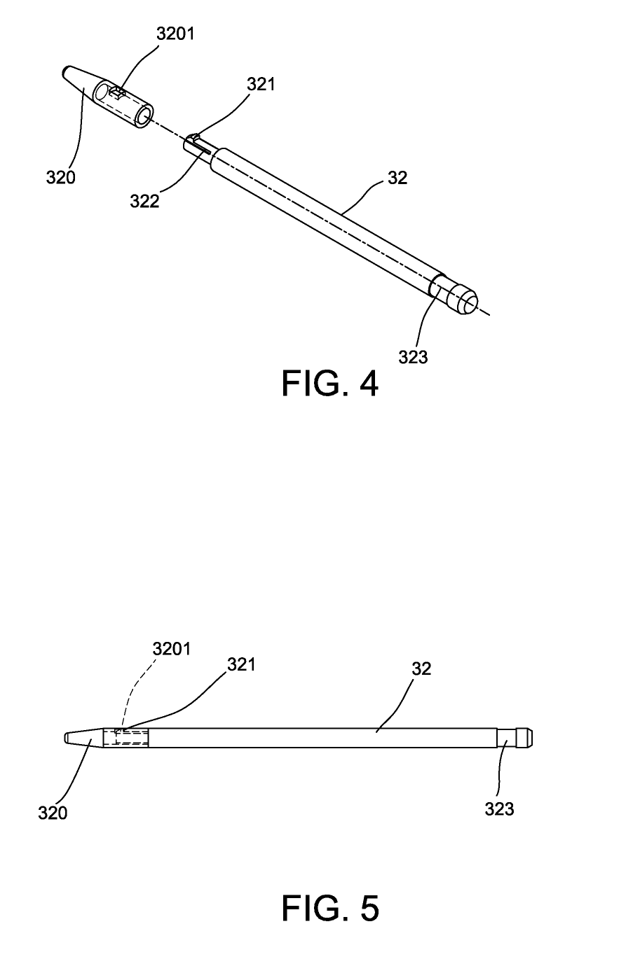

As shown in FIG. 4, the head part 320 and the probe 32 are two individual parts, and the head part 320 has a positioning member 3201 and the probe 32 has an insertion 321. The positioning member 3201 of the head part 320 is a hole and the insertion 321 of the probe 32 is a latch which is engaged with the positioning member 3201 to connect the head part 320 to the probe 32. The insertion 321 of the probe 32 is located between two slits 322 which provide the insertion 321 with flexibility. The head part 320 located in the nozzle 31.

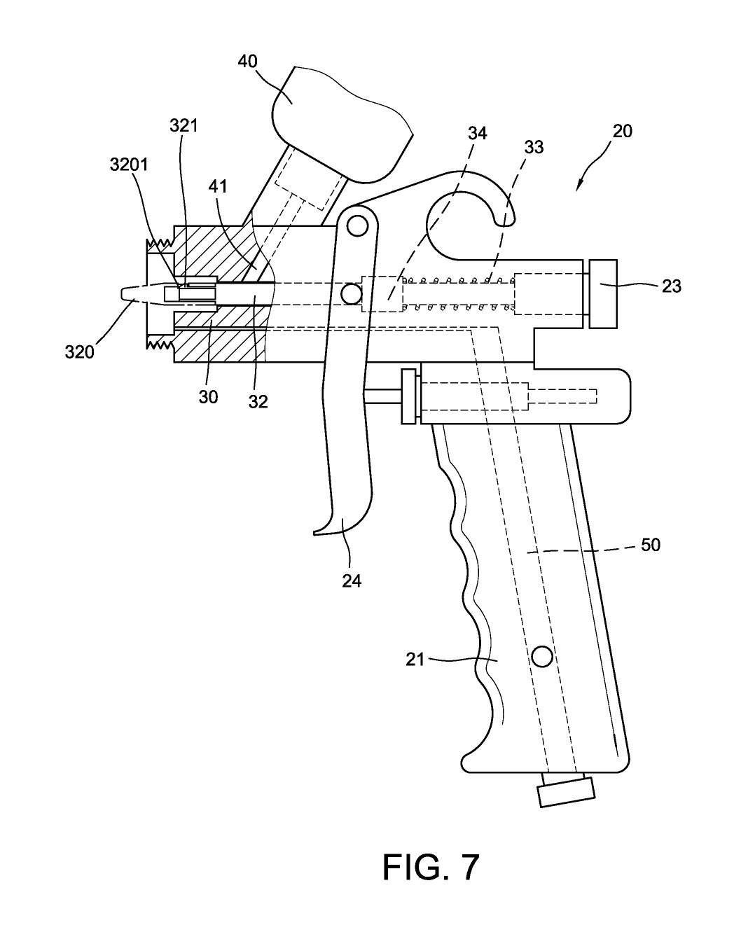

When replacing the nozzle 31 or cleaning the paint way 311 in the nozzle 31, the probe 32 does not need to be replaced or removed, only the head part 320 needs to be replaced. The air unit 22 and the nozzle 31 are first removed as shown in FIG. 7, and the head part 320 is removed from the front end of the spray gun 20. The nozzle 31 can be easily replaced or the paint way 311 can be easily cleaned. When separating the head part 320, the user presses the insertion 321 which is then removed from the positioning member 3201. The head part 320 is then separated from the probe 32.

The spring 33, the block 34 and the adjustment knob 23 are maintained at their positions. The time required to separating the head part 320 is much lesser than the conventional spray gun, and the assembly processes are simple and can be completed from the front end of the spray gun 20. The life of the probe 32 is prolonged and the cost for material of the probe 32 is saved.

When the probe 32 is to be replaced, the user simply uses a hand tool to clamp and rotate the clamp portion 323 of the probe 32, the probe 32 is then ready to be removed and replaced.

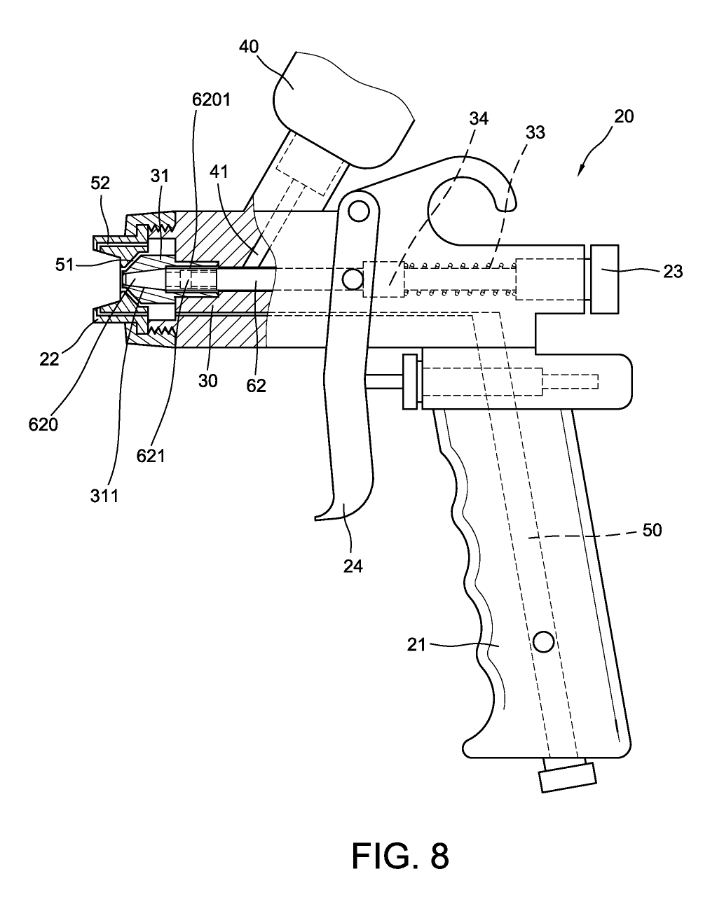

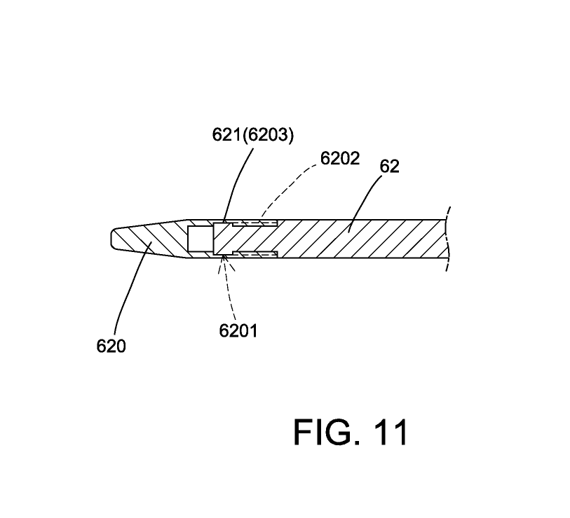

FIGS. 8 to 12 show the second embodiment of the present invention, wherein the spray gun 20 comprises a body 30, a container 40 and an air path 50. The spray gun 20 has a handle 21, an air unit 22, an adjustment knob 23, a trigger 24 and the container 40 connected thereto. The trigger 24 is a lever which controls the communication of the air path 50 and the backward movement of a probe 62. The probe 62 has a head part 620 connected to a front end thereof. The body 30 is connected to the rear end of the air unit 22 and a nozzle 31 is connected to the front end of the body 30. The nozzle 31 has a paint way 311 defined therethrough and the head part 620 of the probe 62 is inserted into the paint way 311. A block 34, a spring 33 and an adjustment knob 23 are connected to the rear end of the probe 62. The rear end of the probe 62 has a recessed clamp portion 623. The container 40 has a guide tube 41 connected thereto which is inserted into paint way 311 in the body 30. The air path 50 has two sub-paths 51, 52 respectively communicating with the air unit 22 and the nozzle 31.

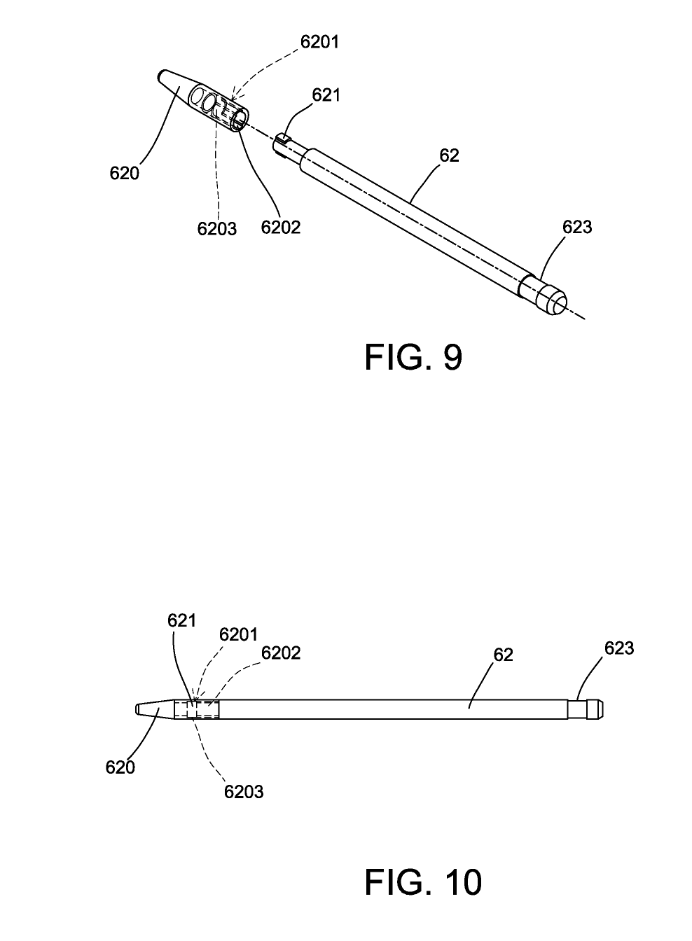

As shown in FIG. 9, the head part 620 and the probe 62 are two individual parts. The head part 620 has a positioning member 6201 and the probe 62 has an insertion 621. The positioning member 6201 of the head part 620 has two axial slots 6202 and an annular groove 6203 defined in the inside thereof. The insertion 621 of the probe 62 has two latches which are engaged with the annular groove 6203 via the axial slots 6202, and the two latches are rotated an angle to be engaged with the annular groove 6203 so as to connect the head part 620 to the probe 62. The head part 620 located in the nozzle 31.

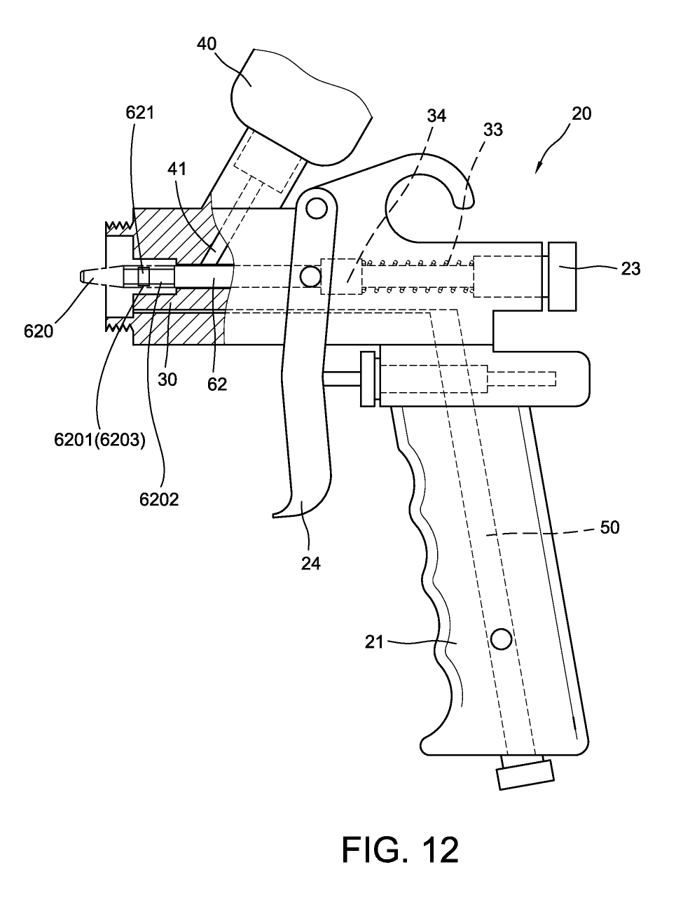

When replacing the nozzle 31 and replacing the head part 620, the air unit 22 and the nozzle 31 are first removed as shown in FIG. 12, and the head part 620 is removed from the front end of the spray gun 20. The nozzle 31 can be easily replaced or the air unit 22 and the nozzle 31 can be easily cleaned. The probe 62 does not need to be replaced. When separating the head part 620, the user rotates the head part 620 to align the axial slots 6202 with the insertion 621. The insertion 621 is then separated from the axial slots 6202. The head part 620 is then separated from the probe 62.

The spring 33, the block 34 and the adjustment knob 23 are maintained at their positions. The time required to separating the head part 620 is much lesser than the conventional spray gun, and the assembly processes are simple and can be completed from the front end of the spray gun 20. The life of the probe 62 is prolonged and the cost for material of the probe 62 is saved.

When the probe 62 is to be replaced, the user simply uses a hand tool to clamp and rotate the clamp portion 623 of the probe 62, the probe 62 is then ready to be removed and replaced.

The probe 32 and the head part 320 of the present invention can also be connected to each other by threads.

While we have shown and described the embodiment in accordance with the present invention, it should be clear to those skilled in the art that further embodiments may be made without departing from the scope of the present invention.

What is claimed is:

1. A spray gun comprising:
a handle, an air unit, an adjustment knob, a trigger, an air path and a container, the trigger controlling communication of the air path and backward movement of a probe, the probe having a head part connected to a front end thereof;
a body connected to a rear end of the air unit and a nozzle connected to a front end of the body, the nozzle having a paint way defined therethrough, the head part of the probe inserted into the paint way, a block, a spring and an adjustment knob connected to a rear end of the probe, the container having a guide tube connected thereto which is inserted into the body, the air path having two sub-paths respectively communicating with the air unit and the nozzle, the two sub-paths adapted to guide paint in the container to be ejected from the nozzle via the paint way in the body, the probe having a middle portion thereof pivotably connected to the trigger, the probe being pulled backward by pulling the trigger, the probe returning by the spring, the head part having a positioning member and the probe having an insertion which is engaged with the positioning member to connect the head part to the probe, the head part located in the nozzle.

2. The spray gun as claimed in claim 1, wherein the positioning member of the head part is a hole and the insertion of the probe is a latch.

3. The spray gun as claimed in claim 2, wherein the insertion of the probe is located between two slits which provide the insertion with flexibility.

4. The spray gun as claimed in claim 1, wherein the positioning member of the head part has two axial slots and an annular groove defined in an inside thereof, the insertion of the probe has two latches which are engaged with the annular groove via the axial slots, and the two latches are rotated an angle to be engaged with the annular groove.

5. The spray gun as claimed in claim 1, wherein a clamp portion is formed at a rear end of the probe.
